(19) United States
(12) Patent Application Publication
(10) Pub. No.: US 2016/0021050 A1
(43) Pub. Date: Jan. 21, 2016

(54) EVENT MESSAGE SYSTEM

(71) Applicants: Jianhua Zhou, Parker, CO (US); Shuangjin Xia, Greenwood Village, CO (US)

(72) Inventors: Jianhua Zhou, Parker, CO (US); Shuangjin Xia, Greenwood Village, CO (US)

(21) Appl. No.: 14/335,899

(22) Filed: Jul. 19, 2014

(51) Int. Cl. H04L 12/58

(52) U.S. Cl. CPC H04L 51/24; H04L 51/20

(57) ABSTRACT

A dynamic message system that the receiver is able to set the criteria to receive messages and the sender sends messages with geographic location and valid period of time attached.

### BACKGROUND OF THE INVENTION

The present invention is in the technical field of computer software application. More particularly, the present invention is in the technical field of event message system application.

Conventional messaging system application, such as SMS system, WeChat®, Whatsapp®, is typically controlled by the sender who sends the messages. The sender decides who will receive what message. It is difficult for businesses to send out messages, such as sales event, promotion event and others, to customers who are really interested on those messages. Further, messages sent out may exist in the system forever if they are not removed purposely, which makes more difficult for the customer to find the useful messages.

### SUMMARY OF THE INVENTION

The present invention is an event message system, in which the receiver is able to setup criteria to decide what kind of event messages they will receive. The event message system also allows the sender to set valid period and geographic location on the event message when posting an event message.

### BRIEF DESCRIPTION OF THE DRAWINGS

The teaching of the present invention can be readily understood by considering the following detailed description in the conjunction with the accompanying drawings, in which:

FIG. 1 is an overview of the event message system to the present invention;

FIG. 2 is flow diagram illustrating event message server application;

FIG. 3 is flow diagram of event message application on mobile device or computer;

FIG. 4 illustrates an exemplary database entry in which event message and its valid period and location are stored, so that a computing device user can retrieve the proper event messages on the user's computing device;

FIG. 4a illustrates a variant of the exemplary database entry in which event start date/time and end start/time are used.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

One or more of the following terms may be referred to in the description that follows.

A “mobile device” refers to a portable, wireless device that typically has a display. Example mobile devices include, for example, smart phones, tablet PCs, personal data assistants (PDAs), e-book readers, and so forth.

A “comment message” may refer to one of any text, audio, video and or combination therefore, such as advertising or comment.

An “event message” is a combination of the message, such as one of any text, audio, video and or combination, the geographic location of the event and the valid period of the event. Example event message include, for example, “summer clearance sale, buy one get one free for entire store”, geographic location 123 Main Street, Denver, Colo., Start Date: 06/04/2014, ends in 7 days.

A “message” may refer a comment message or an event message.

An “event ID” is a unique id to identify the event message.

A “user ID” is a unique id to identify the user, for example a system generated unique ID, or an email address, or a phone number.

“Message sender” generally refers to someone who posts the event or message.

“Message receiver” generally refers to someone who receives the event or message.

“Message sender” and “message receiver” may refer to same person in real world.

A “geographic area” is, but not limited to, an area covered by any kind of shape, a zip code, an administrative area and any combination.

A “criteria” apply the event search conditions, such as but not limited to, a geographic area, a specific category of the product, a specific brand name, a specific store name and any combination.

A “system” generally refers to an entire collection of physical objects and associated software, such as servers, Internet, mobile devices, mobile networks and so forth.

Methods and apparatus of the present invention provide an event message system that message receiver controls how to posting message by setting the criteria, such as in a specific distance, in specific area, or for specific store, when retrieving from event message system server, and message sender can set valid start date/time and valid period when an event message is posted to server.

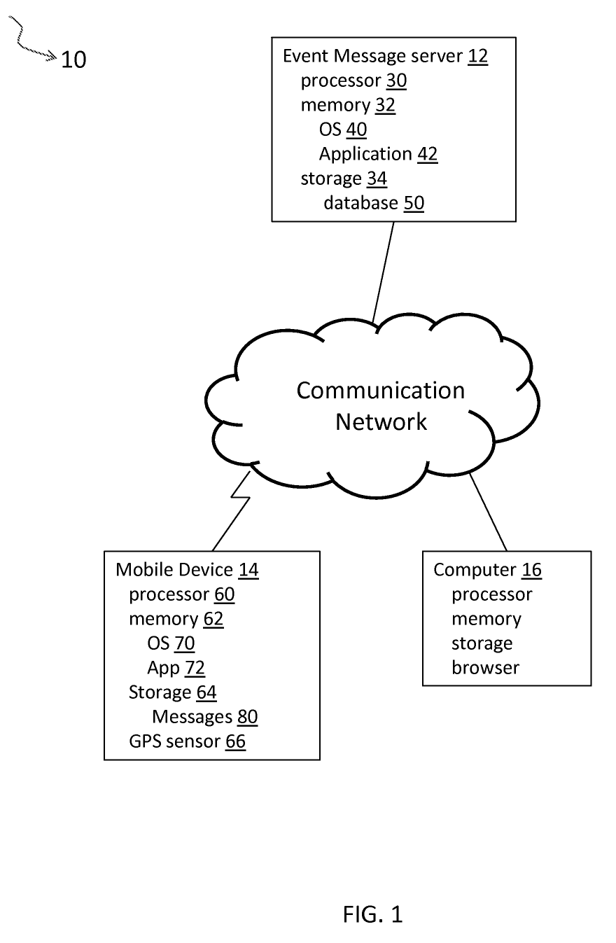

As shown in FIG. 1, one or more mobile devices 14 linked wirelessly to the Internet and connected to the event message server 12.

The mobile devices 14 can include a processor 60, a memory 62, a global position system (GPS) system 66, and storage 64 which store the messages 80. The memory 62 includes an operating system 70, such as Apple IOS®, Google Android® or Microsoft Windows Mobile®, and an event message system application (App) 72. The App 72 includes a function to post message to event message server, a function to retrieve messages according to the criteria set by the message receiver from the event message server. The mobile device 14 may support any one of various mobile technologies, such as 2G, 2.5G, 3G and 4G/LTE, along with supporting SMS messaging (i.e., texting) and data exchange.

The event message server 12 handles the request from the mobile device 14 or the computer 16. The event message server can include a processor 30, a memory 32, and storage 34 which stores the messages in the databases 50. The memory 32 includes an operation system 40, such as Linux® or Windows®, and an event message server application 42.

In one embodiment, the event message App 72, residing on the mobile device 14, collects the message content, valid date/time and geographic location, then sends to the event message server 12.

The event message server application 42 residing on the event message server 12 receives the “posting message request” sent from the event message App 72 in the mobile device 14, saves the event message to the database 50.

In another embodiment, the event message App 72, residing on the mobile device 14, gets the geographic location and search criteria, then sends the retrieval request to the event message server 12. The event message server application 42 residing on the event message server 12 receives the retrieval request sent by the mobile device 14, and retrieves the corresponding message from the database 50 according to the search criteria, and sends the message back to mobile device 14. The event message App 72 on the mobile device 14 get the message and choose the message that meet the current condition, such as current geographic location, to show on the mobile device.

A location of the mobile device 14 is defined by its current global positioning system (GPS) coordinates (i.e., latitude, longitude, altitude), which may be supplemented with further positional information, such as a surrounding neighborhood, a street name, a highway location, a proximity to mall/airport/hotels/stadiums, nearby businesses, and so forth.

The location of mobile device 14 is defaulted to the current geographic location when the request to the event message server 12 is sent. User can pick a geographic location from the map when the user posts message to the event message server.

In operation, the mobile device 14 send the retrieval request to the event message server 12 from time to time, the event message 12 send back the new message to the mobile device 14, the mobile device 14 choose the right message to display on the mobile device 14.

The mobile device 12 send a posting message request when the device user wants to post an event message or a comment message following an event.

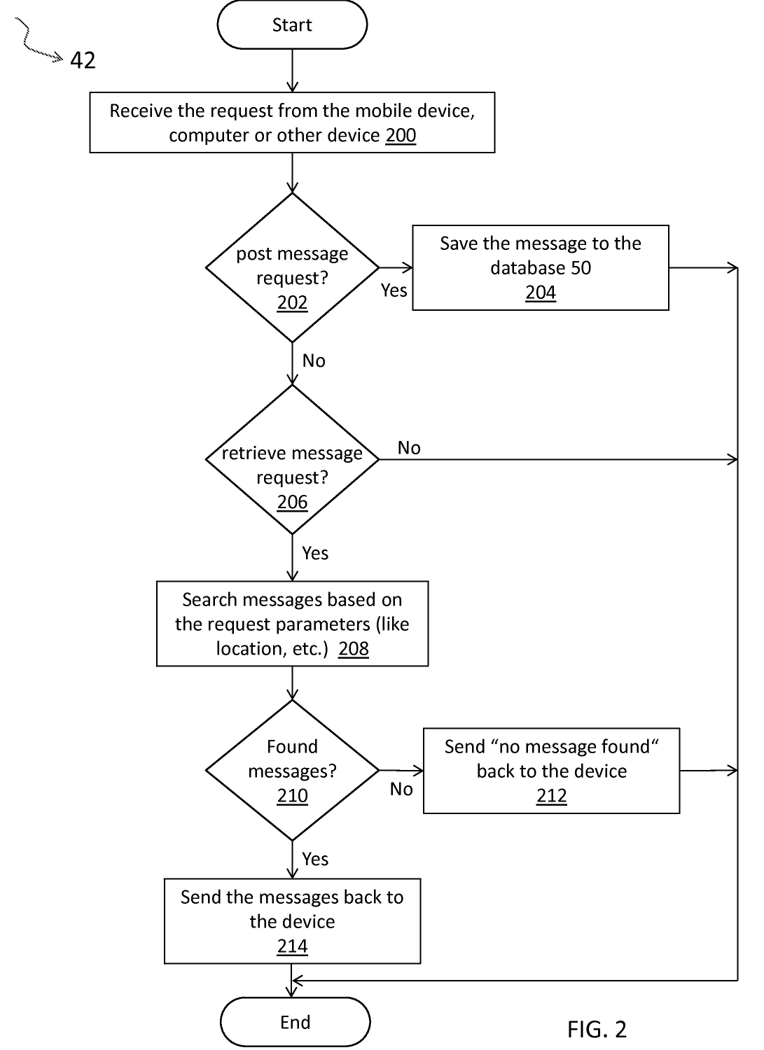

As shown in FIG. 2, the event message server application 42 residing in the event message server 12 include receiving (200) the request from the mobile device 14 or the computer 16. The typical request includes a “posting message” request, or a “retrieving message” request.

The “posting message” request include a message, which could be comment or event message. The event message include the content, such as text, picture, video or some other format info as said before, an event message valid period and a geographic location.

The “retrieving message” request include a geographic location and search criteria.

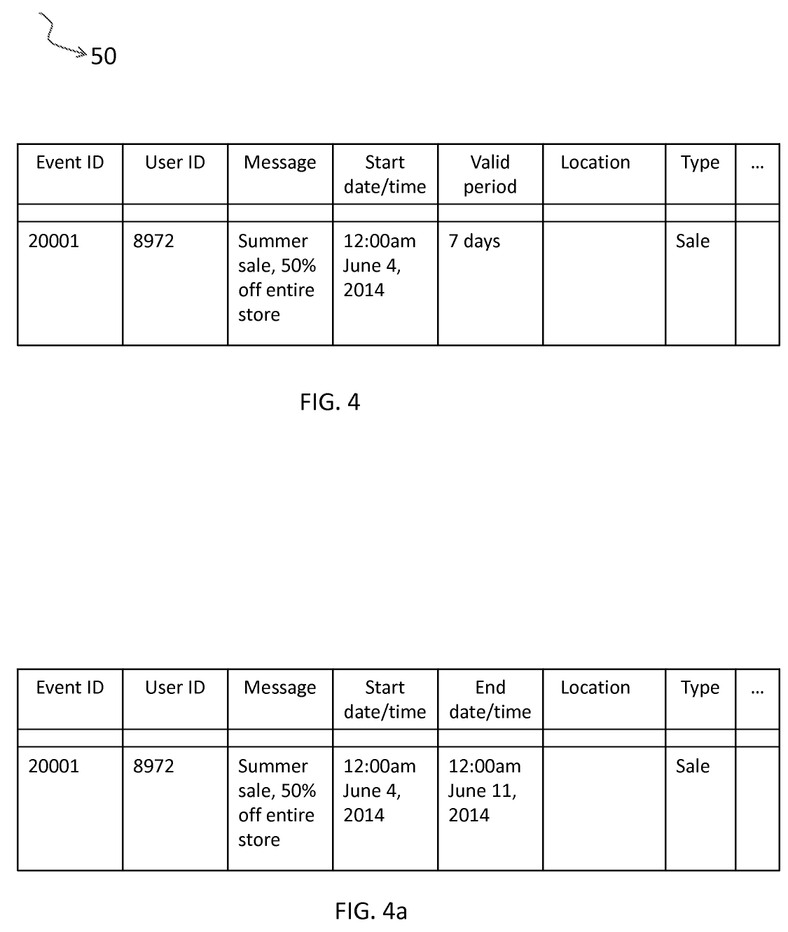

The event message application 42 in the event message server 12 check the request sent by the mobile device 12 or the computer 16, if the request is a posting message request (202), the event message application 42 save (204) the content, geographic location, valid period and other necessary information into database 50. If the request is a retrieving message request (206), the application 42 form the search parameter from the search criteria and the geographic location, which is sent by the mobile device 14 or the computer 16, search (208) the database 50, send (212 or 214) back the message to the mobile device 14 or computer 16. One database structure example is shown in FIG. 4.

In one embodiment, the mobile device 14 or the computer 16 can post an on-sale event message for advertisement. For example, a grocery store has an on-sale event going on for a week. The advertiser can send a posting message request by the mobile device 14 to the event message system with specific instruction, the geographic location (the geographic location can be the geographic location of the mobile device 14, or the geographic location of the store, or chose anywhere on the map), advertiser content, such as shrimp on sale, half price, beef buy one get one free, and an expiration date, like 07/12/2014. The application 42 receive the posting message request send by the mobile device 14, save the content, geographic location, expiration date and other necessary info into database 50. After the expiration date, this message along with the follow up messages removed from the database and maybe saved to some archive database system.

In another embodiment, the mobile device 14 send the retrieving message request to the application 42 residing in the event message server, and display event message near the mobile device 14. For example, the search criteria on the mobile device 14 may be, but not limited to, all message in 5 miles around, and message about the grocery store. The mobile device 14 send the retrieve request, such as, but not limit to, event message for grocery store in 15 miles around the mobile device 14, to the event message server 12. The application 42 receive the retrieve request, and retrieve the message from database 50 which meet the condition of event message for grocery store inside 15 miles around the mobile device 14, send back messages to the mobile device to display the message for grocery in 5 miles near the mobile device. In this embodiment, we search message for bigger area (15 miles radius), but just show message for specific area (5 miles radius). Doing this may reduce work load on the event message server 12 and data traffic between mobile device and the server.

In operation, the application 42 take some other request such as, but not limited to, user account creation, account profile setup, account management.

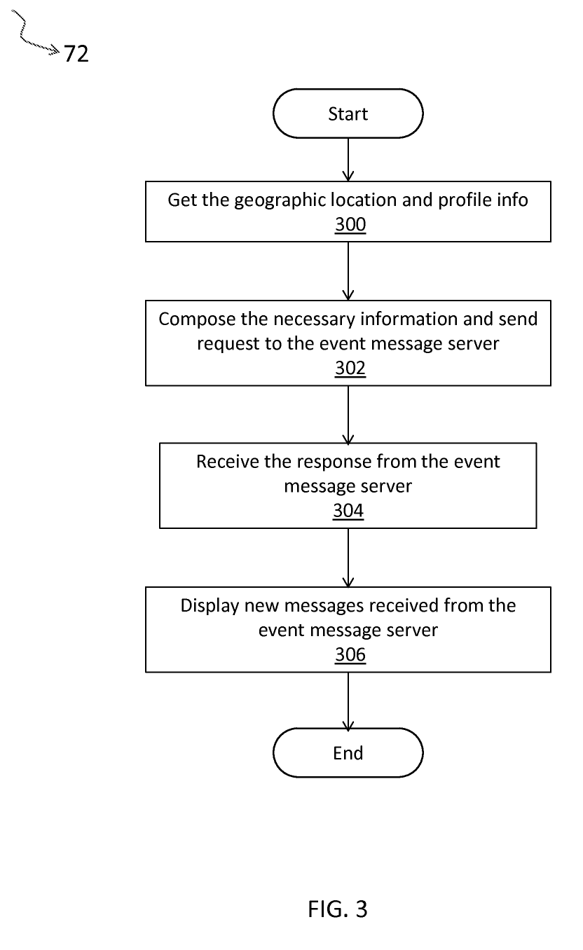

As shown in FIG. 3, the event message app 72 residing in the mobile device 14 or the computer 16 can initiate posting message request to post comment message or event message to the event message server, or retrieving message request to get message from the event message server, or other request.

For retrieving message request, the event message app 72 collect the user criteria and save the criteria for the user. For example, the user criteria can be, but not limited to, event message within 5 miles around me, event message from TheNorthFace® only.

The event message app 72 send the retrieving message request to the event message server 12 and get the event message which meet the criteria set by the user. The app 72 display received message accordingly.

For posting message request, the event message app 72 compose message, which may include the content, the geographic location and the valid period, and send the posting message request to the event message server 12 to post the message. The geographic location may or may not be the same as the geographic location of the mobile device or computer on which app 72 is running. For example, the user can use a mobile device to post an event message for a store sale when the mobile device is not in the store. In another example is that the user can use the computer to post the event message for a store and the computer is not in the store.

The event message app 72 collect the content, the geographic location and the valid period, send the posting message request to the event message server 12 to post an event message for the event.

In one embodiment, the event message app 72 collect the necessary information for the event message, send the posting message request to the event message server 12 to post the event message. For example, a store wants to post a sales event on the event message server. The advertiser upload the content such as ‘Summer Sale, 50% off entire store, June 4 to June 11’, with the geographic location, 1401 Champa St, Denver, Colo. 80202, to the event message server 12. Even though the mobile device 14 or the computer the advertiser uses to post event is not at this location, the advertiser can manually input the location. The event expires on 06/11/2014, which means this event maybe removed from the event message server after the expiration date.

In another example, a user reads an event, he/she would like to post some follow-up message on this event. The user can upload the content, such as “Found some great deals here, will be coming back again!” to the event message server. This message is the follow-up message for this event message.

In another embodiment, the event message app 72 send the retrieve request to the event message server to find the event message that satisfy search criteria. For example, a user set the search criteria as “the event message 5 miles around me”. The event message app 72, obtains the geographic location for the mobile device, and send the retrieve request such as, but not limited to, “the event message 15 miles around the geographic location of the mobile device” to the event server 12, receive the event message 15 miles around the current geographic location of the mobile device, display the event message which is inside 5 miles around the current geographic location of the mobile device. The user can find out the event 5 miles around his/her current location. This is very useful for the customer to find out what is going on around him/her. It is also a useful and convenient platform for businesses to facilitate advertising.

The user also could set up other criteria to show the event message only he/she is interested in, such as, but not limited to, the event message only about a specific store, the event message only about certain category, the event message only about the certain brand name. The category can be, such as, but not limited to, clothing, school supply, grocery, restaurant, entertainment.

As previously noted, the search criteria of the retrieve request sent from the event message app 72 to the event message server 12 may or may not be same as the criteria set in the user profile.

In operation, the event message App 72 may send other request to the event message server 12, such as, but not limited to, account creation, account profile setup, search criteria, and other account management request.

In operation, the event message App 72 may send the retrieve request to the event message server 12 at an interval to retrieve the new event message.

As shown in FIG. 4 and FIG. 4a, the database 50 on message server 12 may include message ID, account ID, message content, valid date/time and valid period, geographic location. It may also include message type and other information, such as rating, etc.

The advantages of the present invention include, without limitation, the event message has the geographic location attribute, the event message has the valid period of time, the message receiver can set the message criteria to choose the message to display.

The present invention enhances the user experience of receiving the event message which the user is interested in, therefore enhance the ability of the advertising and marketing company to reach the right audiences in a dynamic fashion.

As previously noted, the hardware and software systems in which the invention is illustrated are merely representative. The invention may be practiced, typically in software, on one or more machines. Generalizing, a machine typically comprises commodity hardware and software, storage (e.g., disks, disk arrays, and the like) and memory (RAM, ROM, and the like). The particular machines used in the system are not a limitation of the present invention.

In broad embodiment, the present invention is message system in which receiver could setup the criteria about what kind of message they like to receive, which give the user ability to choose what kind of information they like to get, comparing to old fashion way in which the message server send the message to the customer no matter whether they like or not.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the following claims.

What is claimed is:

1. A method comprising:
in a server residing in a network of interconnected computers, the server comprising a processor and a memory, maintaining a repository of message;
receiving a retrieving message request from the mobile device or computer
determining appropriate message to be sent to the mobile device or the computer according to geographic location and search criteria for retrieving message request
sending the appropriate message to the mobile device

2. The method of claim 1 wherein the mobile device comprises:
a processor;
a memory, the memory comprising an operating system and a receiver controlled message system app;
a global positioning system (GPS) system; and
a storage, the storage comprising an message database

3. The method of claim 1 wherein the retrieving message request comprises
a geographic location of the mobile device;
a search criteria of the use;

4. The method of claim 3 wherein the search criteria is, but not limited to, a geographic area, a specific category of the product, a specific brand name, a specific store name and any combination.

5. The method of claim 4 wherein geographic area is, but not limited to, selected from the group of a shape, a zip code, a city, a state, an administrative area.

6. The method of claim 1 wherein the determining comprises:
checking the geographic location and the search criteria in the retrieving message request; and
retrieving the message in the database that meet the search criteria

7. The method of claim 1 further comprising a handling posting message request comprising:
receiving a posting message request from the mobile device or computer
saving the message into repository for posting message request

8. The method of claim 7 wherein the posting message request. The posting message request comprising:
a content of the event;
a geographic location of the event
a valid period of time of the event

9. The method of claim 7 wherein the content is selected from the group consisting of text, audio, video, pictures and images.

10. The method of claim 1 further comprising a request, such as, but not limited to, creating a user, saving the user search criteria, managing system.

11. A method comprising:
in a mobile device or a computer comprising a processor, a memory, a storage and a GPS determining a location of the mobile device from the GPS coordinates;
sending the geographic position and search parameter to a server residing in internet;
receiving the messages from the server related to geographic position and search criteria;
displaying the proper message meet the search criteria in user profile;

12. The method of claim 11 wherein search parameter may or may not as same as search criteria in user profile.

13. The method of claim 11 wherein search criteria in user profile is selected from the group consisting of geographic area, brand name, product category, specific store and similar condition.

14. The method of claim 11 wherein geographic area is, but not limited to, an area covered by any kind of shape, a zip code, an administrative area and any combination.

15. The method of claim 11 further comprising a posting message request. The posting message request comprising:
determining a location of the mobile device from the GPS coordinates;
collecting the information for the event message;
sending the posting message request to the event messages server residing in internet;

16. The method of claim 15 wherein collecting comprising:
choosing a geographic location;
defining a valid time period of the event;
composing the content, which include selected from the group consisting of text, audio, video, pictures and images.

17. A system for providing the event message to the mobile device, comprising:
an event message server resides in the internet for handling the posting message request, the retrieving message request and other management requests;
an event message application resides in the mobile device or the computer for posting the message, receiving the message base on the user criteria and display the message;
a user database system for storing the criteria of the user;
a message database system for storing the messages.

18. The system of claim 17 wherein the event message server comprising:
a process handling a posting message request; and
a process handling a retrieving message request; and
a process handling a user management request

19. The system of claim 18 wherein the process handling a posting message request comprising:
receiving the posting message request; and
saving the message to the message database

20. The system of claim 18 wherein the process handling a retrieving message request comprising:
receiving the retrieving message request; and
determining the messages meet the request; and
sending the message to the mobile device

21. The system of claim 17, wherein the event message application comprising:
posting a message; and
retrieving message meet the criteria; and
managing the user account

22. The system of claim 21 wherein posting a message comprising:
determining the geographic location of the mobile device; and
collecting the information for a comment message or an event message; and
sending the posting message request to the event message server

23. The system of claim 21 wherein retrieving message comprising:
determining the geographic location of the mobile device; and
retrieving the criteria for the mobile device; and
sending the retrieving message request to the event message server

24. The system of claim 17, wherein the message database system comprising, but not limited to:
event ID;
user ID;
message;
start date/time;
end date/time;
valid period;
location; and
type
